(19) United States
(12) Patent Application Publication
(10) Pub. No.: US 2023/0122329 A1
(43) Pub. Date: Apr. 20, 2023

(54) LINEARIZED MAGNET WIRE CONNECTOR

(71) Applicant: ABB Schweiz AG, Baden (CH)

(72) Inventors: Daniel Edwards, Cordova, TN (US); Jonathan Gwaltney, Eads, TN (US)

(21) Appl. No.: 17/504,039

(22) Filed: Oct. 18, 2021

(51) Int. Cl. H01R 4/14; H01R 4/2407

(52) U.S. Cl. CPC H01R 4/14; H01R 4/2407

(57) ABSTRACT

A wire connector includes a member and a channel. A size of the channel is configured to correspond to a width of a largest wire to be connected by the wire connector. The wire connector includes a plurality of projections. The plurality of projections extend from at least one wall forming the channel.

### FIELD

This disclosure relates generally to wire connectors. More particularly, this disclosure relates to wire connectors for connecting a magnet wire or the like.

### BACKGROUND

Magnet wires are often used in motor windings and transformer coils. The magnet wires can be round or rectangular and are generally made of aluminum or copper. The magnet wires include an enamel insulation over the wire that prevents wire-to-wire short circuits in the same coil. The enamel insulation is thin, but tough and, as a result, can be difficult to strip or otherwise remove from the magnet wires when making electrical connections.

### SUMMARY

In some embodiments, a wire connector includes a member. In some embodiments, the wire connector includes a channel formed by the member. In some embodiments, a size of the channel is configured to correspond to a width of a largest wire to be connected. In some embodiments, a height of the channel is configured to correspond to a maximum number of wires to be connected. In some embodiments, the wire connector includes a plurality of projections within the channel. In some embodiments, the plurality of projections extend from at least one wall forming the channel.

In some embodiments, the plurality of projections are configured to pierce an enamel insulation coating of a wire.

In some embodiments, the member is made of copper having a tin coating. In some embodiments, the member is made of aluminum.

In some embodiments, the plurality of projections are stamped into the at least one wall forming the channel.

In some embodiments, the plurality of projections extend from both walls forming the channel.

In some embodiments, the wire connector includes a plurality of adjacent channels.

In some embodiments, the member is spiral-shaped.

In some embodiments, the member includes a plurality of rigid portions connected by a flexible portion.

In some embodiments, the plurality of projections are formed on the plurality of rigid portions.

In some embodiments, a wire connector includes a conductive member including a first wall and a second wall. In some embodiments, a flexible connecting portion joins the first wall and the second wall. In some embodiments, a channel is formed between the first wall and the second wall. In some embodiments, a width of the channel is configured to correspond to a width of a largest wire to be connected. In some embodiments, a height of the channel is configured to correspond to a maximum number of wires to be connected. In some embodiments, the wire connector includes a plurality of projections within the channel. In some embodiments, the plurality of projections extend from one of the first wall or the second wall.

In some embodiments, the plurality of projections each include a plurality of tips.

In some embodiments, the conductive member is made of copper having a tin coating. In some embodiments, the conductive member is made of aluminum.

In some embodiments, the plurality of projections are continuous along a length of the first wall.

In some embodiments, the wire connector includes a second channel adjacent to the channel formed by the first wall and the second wall and formed by a third wall and a fourth wall of the conductive member.

In some embodiments, the conductive member is spiral shaped. In some embodiments, the first wall is a first side of the conductive member and the second wall is a second side of the conductive member opposite the first side.

In some embodiments, the plurality of projections includes a plurality of spikes.

In some embodiments, the first wall and the second wall are rigid.

In some embodiments, the plurality of projections are formed perpendicular to a length of the channel.

In some embodiments, a wire connector includes a conductive member. In some embodiments, the wire connector includes a channel formed by the conductive member. In some embodiments, a width of the channel is configured to correspond to a width of a largest wire to be connected. In some embodiments, a height of the channel is configured to correspond to a maximum number of wires to be connected. In some embodiments, the wire connector includes a plurality of projections within the channel. In some embodiments, the plurality of projections extend from the conductive member.

In some embodiments, the conductive member includes a first wall and a second wall, the second wall being opposite the first wall. In some embodiments, the channel is formed between the first wall and the second wall.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a perspective view of a wire connector, according to some embodiments.

FIG. 2 shows a side view of the wire connector of FIG. 1, according to some embodiments.

FIG. 3 shows a top view of the wire connector of FIG. 1, according to some embodiments.

FIG. 4 shows a perspective view of a wire connector, according to some embodiments.

FIG. 5 shows a side view of the wire connector of FIG. 4, according to some embodiments.

FIG. 6 shows a top view of the wire connector of FIG. 4, according to some embodiments.

FIG. 7 shows a perspective view of a wire connector, according to some embodiments.

FIG. 8 shows a side view of the wire connector of FIG. 7, according to some embodiments.

FIG. 9 shows a top view of the wire connector of FIG. 7, according to some embodiments.

FIG. 10 shows a perspective view of a wire connector, according to some embodiments.

FIG. 11 shows a side view of the wire connector of FIG. 10, according to some embodiments.

Like reference numbers represent the same or similar parts throughout.

### DETAILED DESCRIPTION

Magnet wires are often used in motor windings and transformer coils. The magnet wires can be round or rectangular and are generally made of aluminum or copper. The magnet wires include an enamel insulation over the wire that prevents wire-to-wire short circuits in the same coil. The enamel insulation is thin but tough. As a result, the enamel insulation can be difficult to strip or otherwise remove from the magnet wires. Electrical connectors for magnet wires typically include insulation-piercing features to make contact with the wire conductor material.

Motors often have 1-2 magnet wires per phase. Some motors use windings with 3-5 magnet wires in parallel. Prior wire connectors are limited in how many wires can be joined together because, as larger bundles are created, limited contact with the wire connector is possible. Larger bundles are typically connected with a brazing operation, which burns through the enamel insulation and makes a solid electrical connection, but can be hot, messy and time consuming.

Embodiments of this disclosure provide wire connectors that are capable of joining larger numbers of magnet wire without brazing. In some embodiments, the wire connectors described herein enable connection of magnet wires in a manner that is faster than brazing. In some embodiments, the wire connectors herein can be less prone to error (e.g., faulty connections) than the brazing methods. The wire connectors described herein are designed to align the magnet wires in a linear fashion so that the magnet wires can be joined. The wire connector can be crimped, causing the enamel insulation of the magnet wires to be pierced. As a result, the magnet wires can be conductively coupled via the wire connector. In some embodiments, because of the linear arrangement of the magnet wires, a number of magnet wires that can be joined can be greater than prior wire connectors.

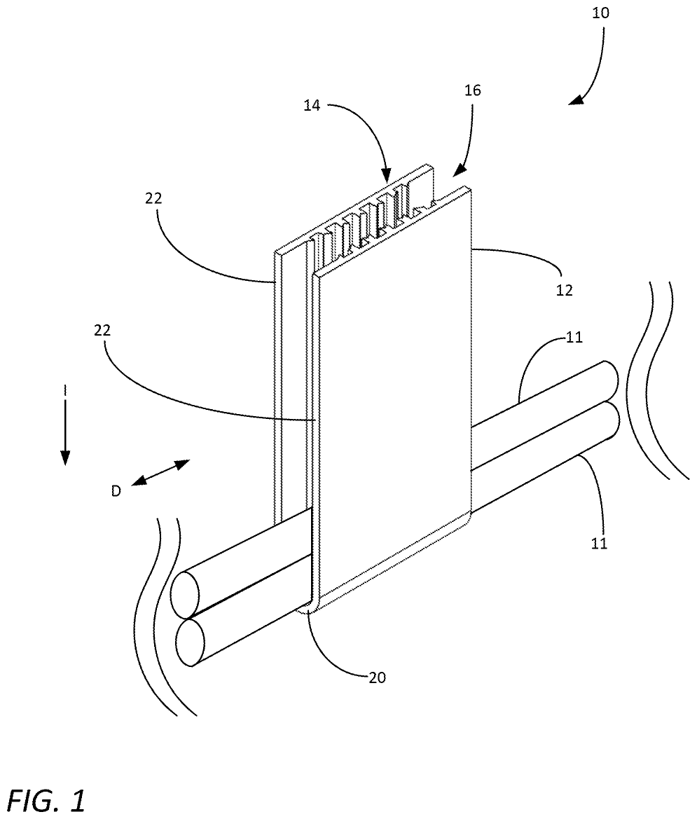

FIG. 1 shows a perspective view of a wire connector 10, according to some embodiments. The wire connector 10 can be used, for example, to conductively couple a plurality of wires 11. In some embodiments, the wire connector 10 as illustrated can be referred to as a vertical connector, a single vertical connector, or the like.

The wire connector 10 includes a member 12 having projections 14. The member 12 is a conductive member. In some embodiments, the member 12 can be made of copper. In some embodiments, the member 12 can be made of copper and then tin plated or otherwise coated with tin. In some embodiments, the member 12 can be a different material, such as, but not limited to, aluminum or the like.

The projections 14 are disposed within a channel 16. In the illustrated embodiment, the projections 14 are arranged to be substantially perpendicular to a direction D corresponding to a longitudinal axis of the wires 11 when installed in the wire connector 10. In some embodiments, substantially perpendicular can include variations from perpendicular. For example, substantially perpendicular can include within 5° of perpendicular, within 10° of perpendicular, or within 15° of perpendicular. Additionally, the projections 14 extend a length of the member 12. Other forms for the projections 14 are possible. For example, in some embodiments, the projections 14 can be a plurality of individual projections that do not extend continuously the length of the member 12. For example, the projections 14 can be individual spikes or the like. In the illustrated embodiment, the direction D is shown as being into or out of the channel 16. In some embodiments, wires 11 can be inserted into the wire connector 10 in a direction I. In some embodiments, the direction I can be from a top-down, relative to the page. In some embodiments, the direction I is from an open end of the wire connector 10 toward a closed end of the wire connector 10. After insertion, the wires 11 can be crimped and any excess can be trimmed. It is to be appreciated that it is possible to alternatively insert the wires 11 in the direction D, according to some embodiments. In some embodiments, the projections 14 can be stamped into the member 12. In some embodiments, the projections 14 can be skived or cut.

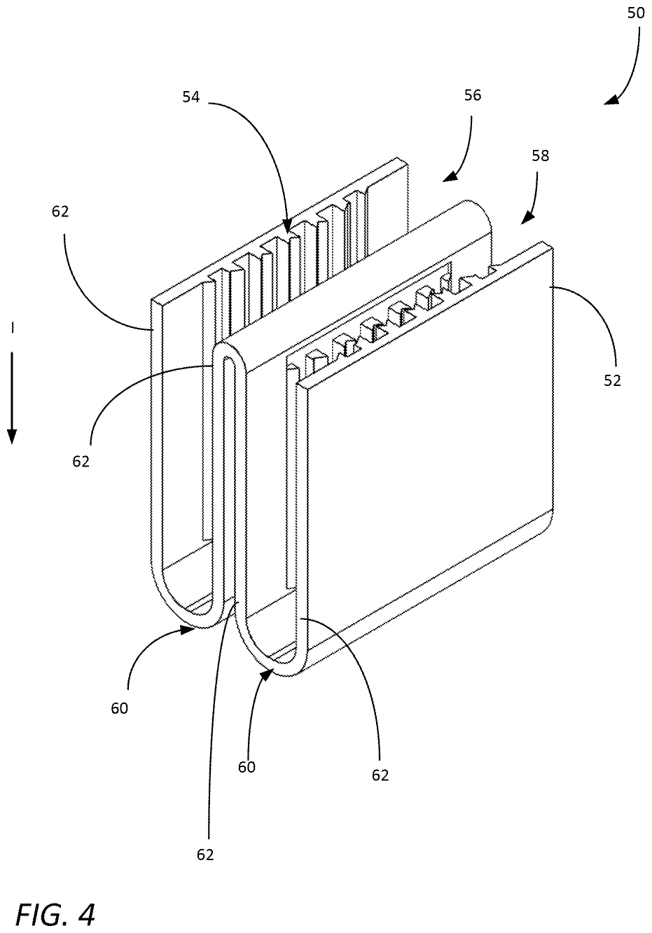

In the illustrated embodiment, the wire connector 10 includes one channel (the channel 16). It is to be appreciated that a different number of channels can be included. For example, in some embodiments, the channel 16 can include one or more additional channels adjacent to the channel 16. Some embodiments are shown and described in additional detail in accordance with FIGS. 4-9 below.

The geometry of the wire connector 10 is such that the channel 16 can vary in width because the member 12 is flexible due to the member 12 having a flexible portion 20 connecting rigid portions 22. The rigid portions 22 include the projections 14. The flexibility of the flexible portion 20 can be selected so that when a wire is inserted into the channel 16, the flexible portion 20 allows the rigid portions 22 to separate. Additionally, the flexible portion 20 can enable the rigid portions 22 to be crimped together once the wires 11 are in place in the channel 16. In some embodiments, the flexible portion 20 can also include the projections 14. In such embodiments, the projections 14 can be continuous between the flexible portion 20 and the rigid portions 22. In some embodiments, it may be easier to manufacture the wire connector 10 including the projections 14 in the flexible portion 20 and the rigid portions 22.

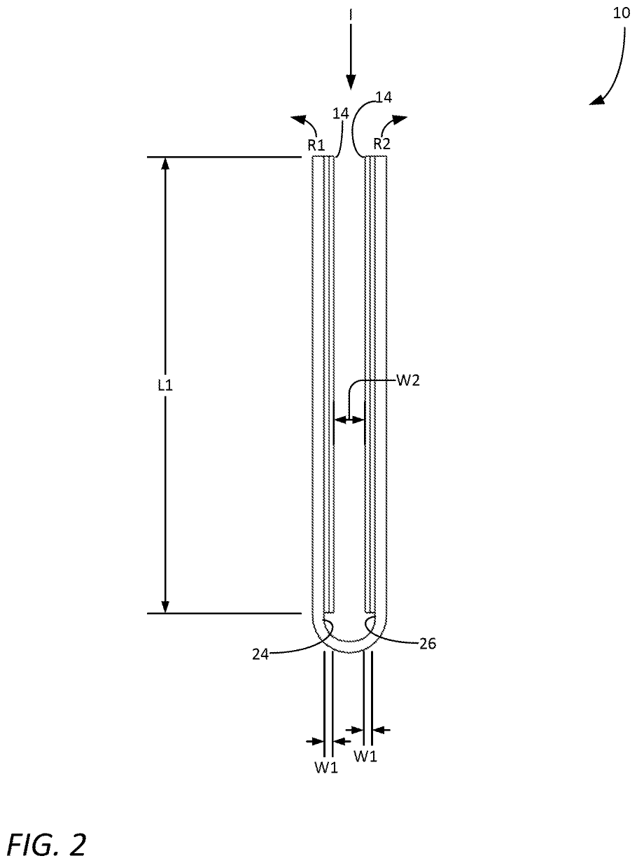

FIG. 2 shows a side view of the wire connector 10, according to some embodiments. The side view is such that the wires (e.g., the wires 11 in FIG. 1) would be inserted to the wire connector 10 in the direction I that is vertically up/down with respect to the page in FIG. 2.

The projections 14 on a wall 24 of the channel 16 can have the same sizing as the projections 14 on a wall 26 of the channel 16. For example, in the illustrated embodiment, the projections 14 on the wall 24 have a length L1 and the projections 14 on the wall 26 have the same length L1. The projections 14 extend a distance W1 from the wall 24 or the wall 26. That is, the amount of extension from the wall 24 (i.e., the distance W1) can be the same as the amount of extension from the wall 26. It is to be appreciated that, in some embodiments, the distance W1 can be varied so that the amount of extension from the wall 24 is different from the amount of extension from the wall 26.

In some embodiments, the projections 14 on the wall 24 of the channel 16 can have different sizing than the projections 14 on the wall 26 of the channel 16. For example, length L1 can be varied for the projections 14 on the wall 24 versus the projections 14 on the wall 26.

A distance W2 between extents of the projections 14 in the channel 16 can be selected according to a size of the wires to be crimped with the wire connector 10. In some embodiments, W2 can be selected so that a variety of wire sizes can be crimped within the channel 16. As discussed above regarding FIG. 1, when a wire is inserted into the channel 16, the wall 24 can deflect (e.g., in a direction R1). In some embodiments, when the wire is inserted into the channel 16, the wall 26 can deflect (e.g., in a direction R2).

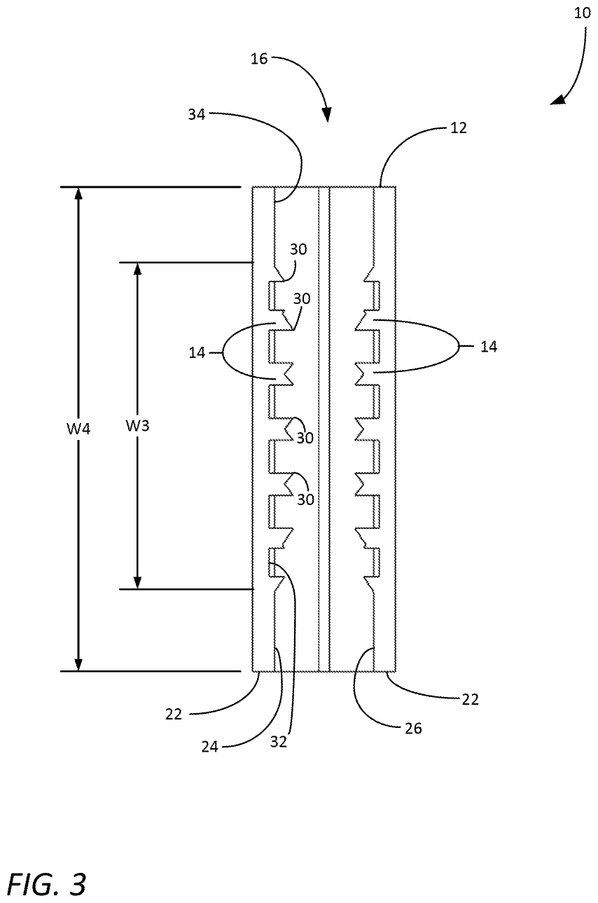

FIG. 3 shows a top view of the wire connector 10, according to some embodiments. The projections 14 are arranged along a portion of the wall 24 and a portion of the wall 26. That is, as illustrated, the wall 24 and the wall 26 have a width W4. The projections 14 are disposed within a portion of the wall 24 and the wall 26 that spans a width W3. As illustrated, W4 is greater than W3.

The projections 14 include at least one tip 30. In the illustrated embodiment, a plurality of the projections 14 include two tips 30. A valley 32 is disposed between each of the projections 14. In some embodiments, a thickness of the rigid portions 22 can be smaller in the valley 32 than in an area 34 which is disposed in an area between an extent of the rigid portions 22 and the outermost of the projections 14. That is, the valley 32 can be recessed into the wall 24.

FIG. 4 shows a perspective view of a wire connector 50, according to some embodiments. The wire connector 50 can be used, for example, to conductively couple a plurality of wires (not shown in FIG. 4). In some embodiments, the wire connector 50 as illustrated can be referred to as a vertical connector, a double vertical connector, or the like.

The wire connector 50 includes a member 52 having projections 54. The member 52 is a conductive member. In some embodiments, the member 52 can be made of copper. In some embodiments, the member 52 can be made of copper and then tin plated or otherwise coated with tin. In some embodiments, the member 52 can be a different material, such as, but not limited to, aluminum or the like.

The projections 54 are disposed within a channel 56 and a channel 58. In the illustrated embodiment, the projections 54 are arranged to be substantially perpendicular to a direction D corresponding to a longitudinal axis of the wires when installed in the wire connector 50. In some embodiments, substantially perpendicular can include variations from perpendicular. For example, substantially perpendicular can include within 5° of perpendicular, within 10° of perpendicular, or within 15° of perpendicular. Additionally, the projections 54 extend a length of the member 52. Other forms for the projections 54 are possible. For example, in some embodiments, the projections 54 can be a plurality of individual projections that do not extend continuously the length of the member 52. For example, the projections 54 can be individual spikes or the like. In the illustrated embodiment, the direction D is shown as being into or out of the channel 56. In some embodiments, wires can be inserted into the wire connector 50 in a direction I. In some embodiments, the direction I can be from a top-down, relative to the page. In some embodiments, the direction I is from an open end of the wire connector 50 toward a closed end of the wire connector 50. After insertion, the wires can be crimped, and any excess can be trimmed. It is to be appreciated that it is possible to alternatively insert the wires in the direction D, according to some embodiments. In some embodiments, the projections 54 can be stamped into the member 52. In some embodiments, the projections 54 can be skived or cut.

In the illustrated embodiment, the wire connector 50 includes two channels (the channel 56 and the channel 58). It is to be appreciated that a different number of channels can be included. For example, in some embodiments, the channel 56 is present but not the channel 58 (e.g., see FIG. 1). In some embodiments, the channel 56 and the channel 58 are both present, along with one or more additional channels adjacent to either the channel 56, the channel 58, or adjacent to both the channel 56 and the channel 58.

The geometry of the wire connector 50 is such that the channel 56 and the channel 58 can vary in width because the member 52 is flexible due to the member 52 having a flexible portion 60 connecting rigid portions 62. The rigid portions 62 include the projections 54. The flexibility of the flexible portion 60 can be selected so that when a wire is inserted into the channel 56 or the channel 58, the flexible portion 60 allows the rigid portions 62 to separate. Additionally, the flexible portion 60 can enable the rigid portions 62 to be crimped together once the wires are in place in the channel 56 and the channel 58. In some embodiments, the flexible portion 60 can also include the projections 54. In such embodiments, the projections 54 can be continuous between the flexible portion 60 and the rigid portions 62. In some embodiments, it may be easier to manufacture the wire connector 50 including the projections 54 in the flexible portion 60 and the rigid portions 62.

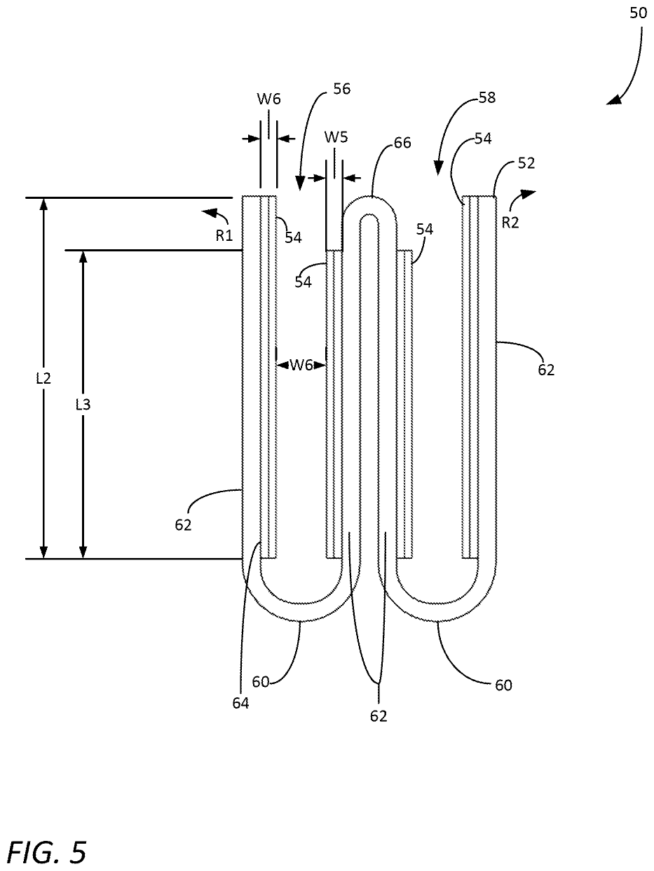

FIG. 5 shows a side view of the wire connector 50, according to some embodiments. The side view is such that the wires would be inserted to the wire connector 50 in the direction I that is vertically up/down with respect to the page in FIG. 5. In the illustrated embodiment, the projections 54 in the channel 56 and the projections 54 in the channel 58 are the same. For simplicity of this Specification, the following description is relative to the channel 56. It is to be appreciated that the description applies to the channel 58 as well. In some embodiments, the channel 56 and the channel 58 can be different.

The projections 54 on a wall 64 of the channel 56 can have different sizing than the projections 54 on a wall 66 of the channel 56. For example, in the illustrated embodiment, the projections 54 on the wall 64 have a length L2 and the projections 54 on the wall 66 have a length L3. In the illustrated embodiment, L2 is greater than L3. L3 can be selected to be smaller than L2 because of a connecting portion 68 which serves to connect the channel 56 and the channel 58. In some embodiments, if the wire connector 50 includes a single channel, L2 and L3 can be designed to be the same. The projections 54 extend a distance W5 from the wall 64 or the wall 66. That is, the amount of extension from the wall 64 (i.e., the distance W5) can be the same as the amount of extension from the wall 66. It is to be appreciated that, in some embodiments, the distance W5 can be varied so that the amount of extension from the wall 64 is different from the amount of extension from the wall 66.

A distance W6 between extents of the projections 54 in the channel 56 can be selected according to a size of the wires to be crimped with the wire connector 50. In some embodiments, W6 can be selected so that a variety of wire sizes can be crimped within the channel 56 or the channel 58. In some embodiments, W6 in the channel 56 and W6 in the channel 58 can be different. As discussed above regarding FIG. 4, when a wire is inserted into the channel 56, the wall 64 can deflect (e.g., in a direction R1) and/or the wall 66 can deflect (e.g., in a direction R2).

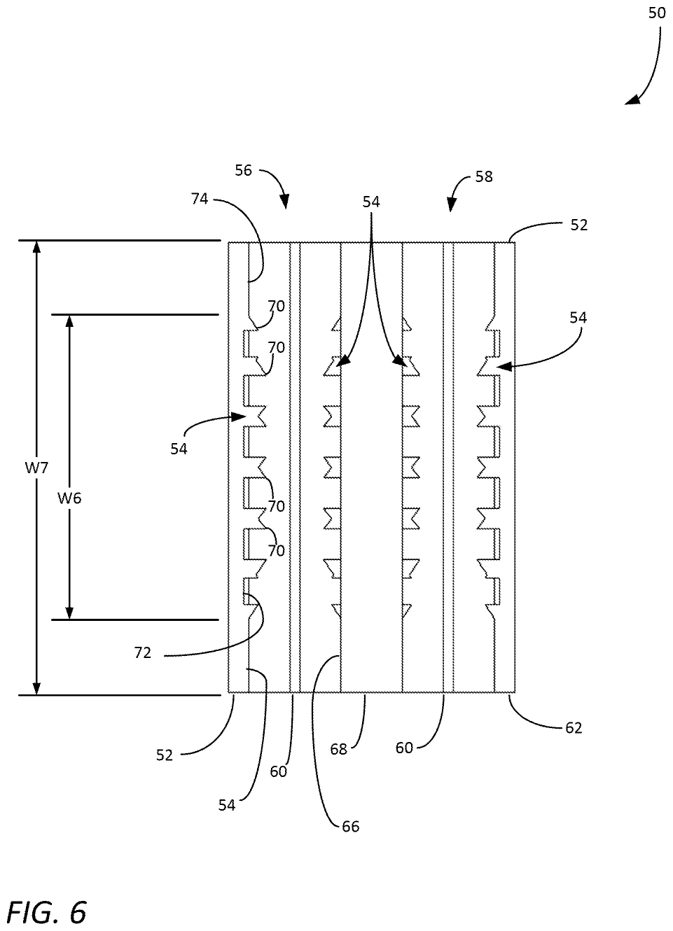

FIG. 6 shows a top view of the wire connector 50, according to some embodiments. The projections 54 are arranged along a portion of the wall 64 and a portion of the wall 66. That is, as illustrated, the wall 64 and the wall 66 have a width W7. The projections 54 are disposed within a portion of the wall 64 and the wall 66 that spans a width W8. As illustrated, W7 is greater than W8.

The projections 54 include at least one tip 70. In the illustrated embodiment, a plurality of the projections 54 include two tips 70. A valley 72 is disposed between each of the projections 54. In some embodiments, a thickness of the rigid portions 62 can be smaller in the valley 72 than in an area 74 which is disposed in an area between an extent of the rigid portions 62 and the outermost of the projections 54. That is, the valley 72 can be recessed into the wall 64.

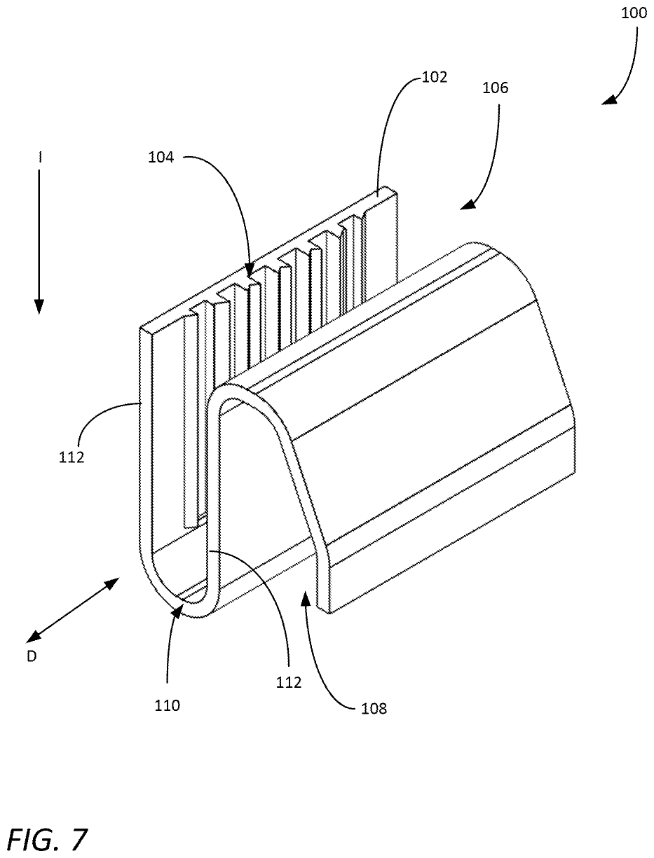

FIG. 7 shows a perspective view of a wire connector 100, according to some embodiments. The wire connector 100 can be used, for example, to conductively couple a plurality of wires (not shown in FIG. 7). In some embodiments, the wire connector 100 as illustrated can be referred to as a lead wire connector, a single vertical connector, a vertical connector, or the like.

The wire connector 100 includes a member 102 having projections 104. The member 102 is a conductive member. In some embodiments, the member 102 can be made of copper. In some embodiments, the member 102 can be made of copper and then tin plated or otherwise coated with tin. In some embodiments, the member 102 can be a different material, such as, but not limited to, aluminum or the like.

The projections 104 are disposed within a channel 106. In the illustrated embodiment, the projections 104 are arranged to be substantially perpendicular to a direction D corresponding to a longitudinal axis of the wires when installed in the wire connector 100. In some embodiments, substantially perpendicular can include variations from perpendicular. For example, substantially perpendicular can include within 5° of perpendicular, within 10° of perpendicular, or within 15° of perpendicular. Additionally, the projections 104 extend a length of the member 102. Other forms for the projections 104 are possible. Additionally, the projections 104 extend a length of the member 102. Other forms for the projections 104 are possible. For example, in some embodiments, the projections 104 can be a plurality of individual projections that do not extend continuously the length of the member 102. For example, the projections 104 can be individual spikes or the like. In the illustrated embodiment, the direction D is shown as being into or out of the channel 106. In some embodiments, wires can be inserted into the wire connector 100 in a direction I. In some embodiments, the direction I can be from a top-down, relative to the page. In some embodiments, the direction I is from an open end of the wire connector 100 toward a closed end of the wire connector 100. After insertion, the wires can be crimped and any excess can be trimmed. It is to be appreciated that it is possible to alternatively insert the wires in the direction D, according to some embodiments. In some embodiments, the projections 104 can be stamped into the member 102. In some embodiments, the projections 104 can be skived or cut.

In the illustrated embodiment, the wire connector 100 includes one channel (the channel 106) for magnet wires and one channel 108 for an uninsulated lead wire. In some embodiments, the lead wire can be stranded or solid, and it can be insulated with regular insulation, but the end that will get crimped can be stripped first. It is to be appreciated that a different number of channels can be included. For example, in some embodiments, one or more additional channels can be disposed adjacent to the channel 106.

The geometry of the wire connector 100 is such that the channel 106 can vary in width because the member 102 is flexible due to the member 102 having a flexible portion 110 connecting rigid portions 112. The rigid portions 112 include the projections 104. The flexibility of the flexible portion 110 can be selected so that when a wire is inserted into the channel 106, the flexible portion 110 allows the rigid portions 112 to separate. Additionally, the flexible portion 110 can enable the rigid portions 112 to be crimped together once the wires are in place in the channel 106. In some embodiments, the flexible portion 110 can also include the projections 104. In such embodiments, the projections 104 can be continuous between the flexible portion 110 and the rigid portions 112. In some embodiments, it may be easier to manufacture the wire connector 100 including the projections 104 in the flexible portion 110 and the rigid portions 112.

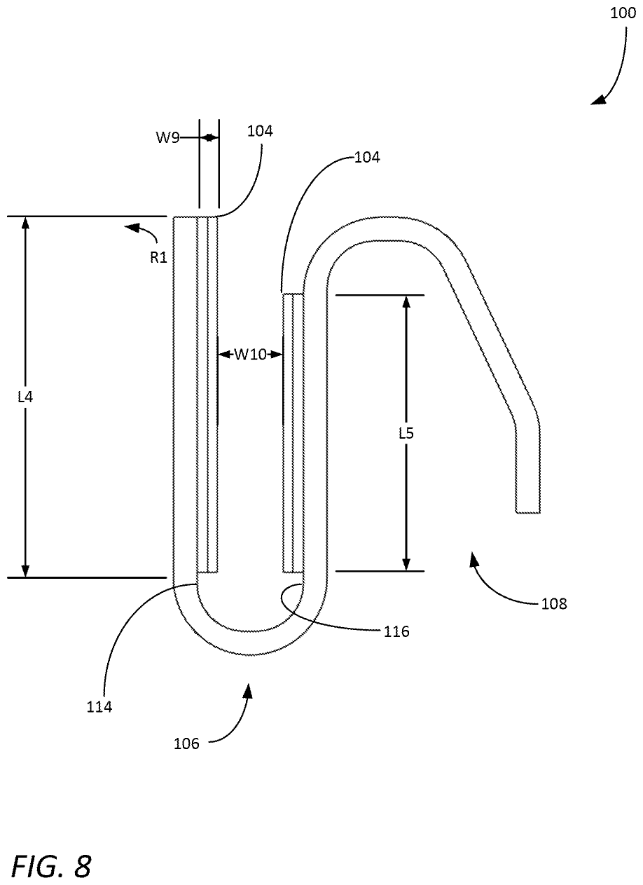

FIG. 8 shows a side view of the wire connector 100, according to some embodiments. The side view is such that the wires would be inserted to the wire connector 100 in the direction I that is vertically up/down with respect to the page in FIG. 8. A lead wire would be installed from a bottom (opposite direction to I, e.g., vertically down/up with respect to the page) or from a side (e.g., into or out from the page).

The projections 104 on a wall 114 of the channel 106 can have different sizing than the projections 104 on a wall 116 of the channel 106. For example, in the illustrated embodiment, the projections 104 on the wall 114 have a length L4 and the projections 104 on the wall 116 have a length L5. In the illustrated embodiment, L4 is greater than L5. In some embodiments, L4 and L5 can be designed to be the same. The projections 104 extend a distance W9 from the wall 114 or the wall 116. That is, the amount of extension from the wall 114 (i.e., the distance W9) can be the same as the amount of extension from the wall 116. It is to be appreciated that, in some embodiments, the distance W9 can be varied so that the amount of extension from the wall 114 is different from the amount of extension from the wall 116.

A distance W10 between extents of the projections 104 in the channel 106 can be selected according to a size of the wires to be crimped with the wire connector 100. In some embodiments, W10 can be selected so that a variety of wire sizes can be crimped within the channel 106. As discussed above regarding FIG. 7, when a wire is inserted into the channel 106, the wall 114 can deflect (e.g., in a direction R1).

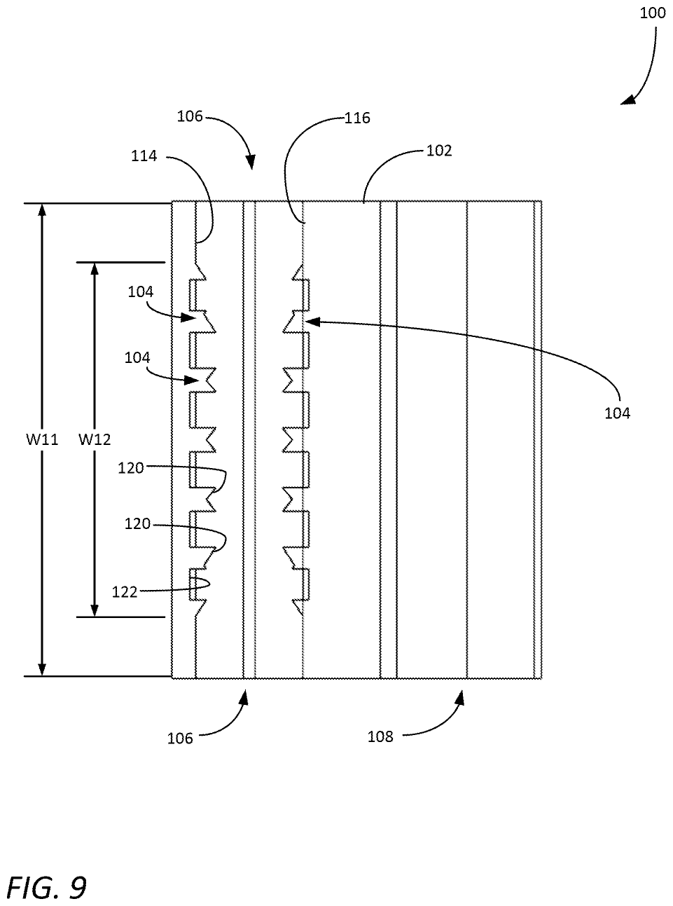

FIG. 9 shows a top view of the wire connector 100, according to some embodiments. The projections 104 are arranged along a portion of the wall 114 and a portion of the wall 116. That is, as illustrated, the wall 114 and the wall 116 have a width W11. The projections 104 are disposed within a portion of the wall 114 and the wall 116 that spans a width W12. As illustrated, W11 is greater than W12.

The projections 104 include at least one tip 120. In the illustrated embodiment, a plurality of the projections 104 include two tips 120. A valley 122 is disposed between each of the projections 104. In some embodiments, a thickness of the rigid portions 112 can be smaller in the valley 122 than in an area 124 which is disposed in an area between an extent of the rigid portions 112 and the outermost of the projections 104. That is, the valley 122 can be recessed into the wall 114.

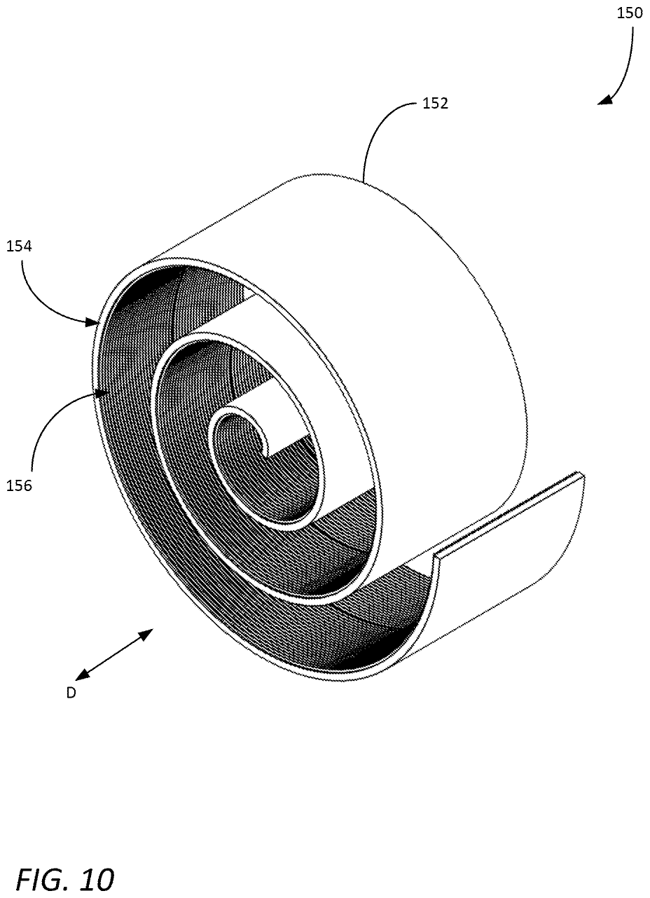

FIG. 10 shows a perspective view of a wire connector 150, according to some embodiments. The wire connector 150 can be used, for example, to conductively couple a plurality of wires (not shown in FIG. 10). In some embodiments, the wire connector 150 as illustrated can be referred to as a spiral connector or the like.

The wire connector 150 includes a member 152 having projections 154. The member 152 is a conductive member. In some embodiments, the member 152 can be made of copper. In some embodiments, the member 152 can be made of copper and then tin plated or otherwise coated with tin. In some embodiments, the member 152 can be a different material, such as, but not limited to, aluminum or the like.

The projections 154 are disposed within a channel 156 formed within a spiral shape of the wire connector 150. In the illustrated embodiment, the projections 154 are arranged to be substantially perpendicular to a direction D corresponding to a longitudinal axis of the wires when installed in the wire connector 150. In some embodiments, substantially perpendicular can include variations from perpendicular. For example, substantially perpendicular can include within 5° of perpendicular, within 10° of perpendicular, or within 15° of perpendicular. Additionally, the projections 154 extend a length of the member 152. Other forms for the projections 154 are possible. For example, in some embodiments, the projections 154 can be a plurality of individual projections that do not extend continuously the length of the member 152. For example, the projections 154 can be individual spikes or the like. In the illustrated embodiment, the direction D is shown as being into or out of the channel 156. In some embodiments, wires can be inserted into the wire connector 150 in a direction I. In some embodiments, the direction I can be from a top-down, relative to the page. In some embodiments, the direction I is from an open end of the wire connector 150 toward a closed end of the wire connector 150. After insertion, the wires can be crimped and any excess can be trimmed. It is to be appreciated that it is possible to alternatively insert the wires in the direction D, according to some embodiments. In some embodiments, the projections 154 can be stamped into the member 152. In some embodiments, the projections 154 can be skived or cut.

In the illustrated embodiment, the wire connector 150 includes one channel (the channel 156) that is sized based on a number of rotations of the spiral shape of the member 152. It is to be appreciated that a different number of rotations can be included. A number of rotations can be based on, for example, a number of wires to be conductively joined.

Because of the spiral shape of the member 152, the channel 156 can vary in width. The flexibility can be based on, for example, a material selected, a radius of the spiral shape, or any combination thereof. The flexibility can be selected so that wires of varying sizes can be inserted into the channel 156 and crimped together once the wires are in place. In some embodiments, the spiral shape of the member 152 can result in a smaller footprint than a vertical connector. For example, in some embodiments, the width of the wire connector 150 can be smaller than the width of wire connector 10, wire connector 50, or wire connector 100.

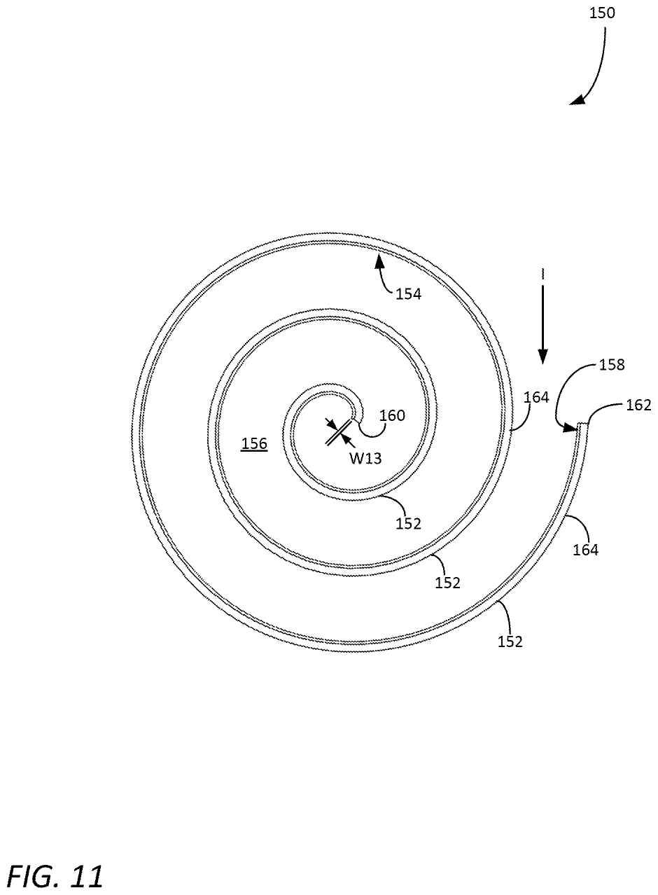

FIG. 11 shows a side view of the wire connector 150, according to some embodiments. The side view is such that the wires would be inserted to or removed from the wire connector 150 in the direction I.

The projections 154 extend a distance W13 from a wall 158 of the member 152. In the illustrated embodiment, the projections 154 can run a length from an extent 160 to an extent 162 of the member 152. It is to be appreciated that the projections 154 can be discrete instead of continuous, according to some embodiments. The continuous projections 154 can simplify a manufacturing process, in which the projections 154 can be formed on the wall 158 and then the member 152 rolled to form the wire connector 150. A second wall 164, opposite the wall 158, can form the channel 156. In some embodiments, the second wall 164 can also include the projections 154.

Aspects:

It is to be appreciated that any one of aspects 1-9 can be combined with any one of aspects 10-18 or 19-20. Any one of aspects 10-18 can be combined with any one of aspects 19-20.

Aspect 1. A wire connector, comprising: a member; a channel formed by the member, wherein a size of the channel is configured to correspond to a width of a largest wire to be connected; wherein a height of the channel is configured to correspond to a maximum number of wires to be connected; and a plurality of projections within the channel, wherein the plurality of projections extend from at least one wall forming the channel.

Aspect 2. The wire connector of aspect 1, wherein the plurality of projections are configured to pierce an enamel insulation coating of a wire.

Aspect 3. The wire connector of one of aspects 1 or 2, wherein the member is made of copper having a tin coating.

Aspect 4. The wire connector of any one of aspects 1-3, wherein the plurality of projections are stamped into the at least one wall forming the channel.

Aspect 5. The wire connector of any one of aspects 1-4, wherein the plurality of projections extend from both walls forming the channel.

Aspect 6. The wire connector of any one of aspects 1-5, wherein the wire connector includes a plurality of adjacent channels.

Aspect 7. The wire connector of any one of aspects 1-6, wherein the member is spiral-shaped.

Aspect 8. The wire connector of any one of aspects 1-7, wherein the member comprises a plurality of rigid portions connected by a flexible portion.

Aspect 9. The wire connector of aspect 8, wherein the plurality of projections are formed on the plurality of rigid portions.

Aspect 10. A wire connector, comprising: a conductive member, comprising a first wall and a second wall; a flexible connecting portion joining the first wall and the second wall; a channel formed between the first wall and the second wall, wherein a width of the channel is configured to correspond to a width of a largest wire to be connected; wherein a height of the channel is configured to correspond to a maximum number of wires to be connected; and a plurality of projections within the channel, wherein the plurality of projections extend from one of the first wall or the second wall.

Aspect 11. The wire connector of aspect 10, wherein the plurality of projections each include a plurality of tips.

Aspect 12. The wire connector of one of aspects 10 or 11, wherein the conductive member is made of copper having a tin coating.

Aspect 13. The wire connector of any one of aspects 10-12, wherein the plurality of projections are continuous along a length of the first wall.

Aspect 14. The wire connector of any one of aspects 10-13, further comprising a second channel adjacent to the channel formed by the first wall and the second wall and formed by a third wall and a fourth wall of the conductive member.

Aspect 15. The wire connector of any one of aspects 10-14, wherein the conductive member is spiral shaped, and the first wall is a first side of the conductive member and the second wall is a second side of the conductive member opposite the first side.

Aspect 16. The wire connector of any one of aspects 10-15, wherein the plurality of projections includes a plurality of spikes.

Aspect 17. The wire connector of any one of aspects 10-16, wherein the first wall and the second wall are rigid.

Aspect 18. The wire connector of any one of aspects 10-17, wherein the plurality of projections are formed perpendicular to a length of the channel.

Aspect 19. A wire connector, comprising: a conductive member; a channel formed by the conductive member, wherein a width of the channel is configured to correspond to a width of a largest wire to be connected; wherein a height of the channel is configured to correspond to a maximum number of wires to be connected; and a plurality of projections within the channel, wherein the plurality of projections extend from the conductive member.

Aspect 20. The wire connector of aspect 19, wherein the conductive member includes a first wall and a second wall, the second wall being opposite the first wall; and wherein the channel is formed between the first wall and the second wall.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A wire connector, comprising:
a member;
a channel formed by the member,
wherein a width of the channel is configured to correspond to a width of a largest wire to be connected;
wherein a height of the channel is configured to correspond to a maximum number of wires to be connected; and
a plurality of projections within the channel,
wherein the plurality of projections extend from at least one wall forming the channel.

2. The wire connector of claim 1, wherein the plurality of projections are configured to pierce an enamel insulation coating of a wire.

3. The wire connector of claim 1, wherein the member is made of copper having a tin coating.

4. The wire connector of claim 1, wherein the plurality of projections are stamped into the at least one wall forming the channel.

5. The wire connector of claim 1, wherein the plurality of projections extend from both walls forming the channel.

6. The wire connector of claim 1, wherein the wire connector includes a plurality of adjacent channels.

7. The wire connector of claim 1, wherein the member is spiral-shaped.

8. The wire connector of claim 1, wherein the member comprises a plurality of rigid portions connected by a flexible portion.

9. The wire connector of claim 8, wherein the plurality of projections are formed on the plurality of rigid portions.

10. A wire connector, comprising:
a conductive member, comprising a first wall and a second wall;
a flexible connecting portion joining the first wall and the second wall;
a channel formed between the first wall and the second wall,
wherein a width of the channel is configured to correspond to a width of a largest wire to be connected;
wherein a height of the channel is configured to correspond to a maximum number of wires to be connected; and
a plurality of projections formed in the channel,
wherein the plurality of projections extend from one of the first wall or the second wall.

11. The wire connector of claim 10, wherein the plurality of projections each include a plurality of tips.

12. The wire connector of claim 10, wherein the conductive member is made of copper having a tin coating.

13. The wire connector of claim 10, wherein the plurality of projections are continuous along a length of the first wall.

14. The wire connector of claim 10, further comprising a second channel adjacent to the channel formed by the first wall and the second wall and formed by a third wall and a fourth wall of the conductive member.

15. The wire connector of claim 10, wherein the conductive member is spiral shaped, and the first wall is a first side of the conductive member and the second wall is a second side of the conductive member opposite the first side.

16. The wire connector of claim 10, wherein the plurality of projections includes a plurality of spikes.

17. The wire connector of claim 10, wherein the first wall and the second wall are rigid.

18. The wire connector of claim 10, wherein the plurality of projections are formed perpendicular to a length of the channel.

19. A wire connector, comprising:
a conductive member;
a channel formed by the conductive member,
wherein a width of the channel is configured to correspond to a width of a largest wire to be connected;
wherein a height of the channel is configured to correspond to a maximum number of wires to be connected; and
a plurality of projections formed in the channel,
wherein the plurality of projections extend from the conductive member.

20. The wire connector of claim 19, wherein the conductive member includes a first wall and a second wall, the second wall being opposite the first wall; and wherein the channel is formed between the first wall and the second wall.
